(19) United States
(12) Patent Application Publication
(10) Pub. No.: US 2023/0080137 A1
(43) Pub. Date: Mar. 16, 2023

(54) VEHICLE MAINTENANCE SUPPORT DEVICE, VEHICLE MAINTENANCE SUPPORT METHOD, AND VEHICLE MAINTENANCE SUPPORT PROGRAM

(71) Applicant: Broadleaf Co., Ltd., Tokyo (JP)

(72) Inventors: Toshifumi NAGANO, Tokyo (JP); Shinichi KUBOTA, Tokyo (JP); Takafumi MISAKI, Tokyo (JP)

(21) Appl. No.: 17/798,948

(22) PCT Filed: Feb. 10, 2021
(86) PCT No.: PCT/JP2021/005078

§ 371 Date: Aug. 11, 2022

(30) Foreign Application Priority Data
Feb. 12, 2020 (JP) 2020-021723

(51) Int. Cl. G06Q 10/06; G06Q 10/00

(52) U.S. Cl. CPC G06Q 10/063112; G06Q 10/20; G06Q 10/06312

(57) ABSTRACT

A vehicle maintenance support device that assigns a work relevant to vehicle maintenance to a worker and a work pit to efficiently and accurately manage the process of the work includes: an attribute data acquisition unit acquiring “vehicle attribute data” indicating attributes of a vehicle; a skill data acquisition unit acquiring “worker skill data” indicating skill information of a worker; an equipment data acquisition unit acquiring “pit equipment data” indicating equipment information of a work pit; a worker/work pit selection unit selecting a worker having a skill required for a specific work and a work pit having required equipment from information of a specific work specified based on the vehicle attributes, the skill information, and the equipment information; a work assignment unit assigning a specific work to the free time of the selected worker and work pit; and a work display unit displaying the assigned specific work for each worker.

### TECHNICAL FIELD

The present invention relates to a vehicle maintenance support device, a vehicle maintenance support method, and a vehicle maintenance support program, and in particular, to a vehicle maintenance support device, a vehicle maintenance support method, and a vehicle maintenance support program for assigning a work relevant to vehicle maintenance to predetermined workers and work pits.

### BACKGROUND ART

In general, there is a vehicle inspection system to ensure the safe driving of vehicles by making regular inspections of vehicles mandatory. Vehicle inspection is to inspect that there is no problem in appearance, safety, or pollution based on the safety standards established by the Ministry of Land, Infrastructure, Transport and Tourism. For example, for automobiles, it is necessary to inspect the condition of automobiles once every two years at the Transportation Bureau or the designated shop for vehicle inspection and maintenance approved by the Transportation Bureau. Then, a vehicle verification that is valid for two years is issued or renewed for automobiles that have passed the inspection.

In addition, regular inspection and maintenance of automobiles are carried out before undergoing vehicle inspections. In general, regular inspection and maintenance of automobiles are carried out at automobile maintenance shops or automobile dealers (dealers). Among these, there are maintenance shops or dealers approved as designated shops for vehicle inspection and maintenance, and there are many places where regular inspection and maintenance and vehicle inspection are carried out as a set.

The process flow when carrying out regular inspection and vehicle inspection as a set at an automobile maintenance shop generally starts with “reservation reception”, proceeds to “preliminary inspection” before warehousing and “acceptance inspection (including maintenance work)”, “intermediate inspection”, and “completion inspection” after warehousing, and then the designated maintenance record book is issued. If the maintenance company recognizes that the designated maintenance record conforms to the safety standards based on the content of the designated maintenance record book, a safety standard conformity certificate and a safety standard conformity mark are issued.

Then, by submitting the necessary documents such as the designated maintenance record book or the safety standard conformity certificate to the Transport Bureau, a new vehicle verification is issued.

Under such circumstances, a system for administrators of automobile maintenance shops and the like to efficiently manage a series of work processes relevant to vehicle maintenance has been proposed (see, for example, PATENT LITERATURES 1 and 2).

A vehicle maintenance reservation system in PATENT LITERATURE 1 is configured to include a schedule management DB in which time schedules for each vehicle maintenance pit are stored, a work item DB in which vehicle maintenance work items are stored, a customer information DB in which customer information is stored, a control computer for controlling data input and output to each DB, and a terminal computer connected to the control computer.

With the above configuration, when setting the vehicle maintenance schedule, information necessary for the vehicle maintenance reservation can be easily acquired by associating the pieces of information of the respective databases with each other.

In addition, in a process planning device of PATENT LITERATURE 2, a predetermined work process is selected from the process management table displayed on the display screen, and when a user operation for moving to the personnel management table is received, the selected work process is assigned to the personnel management table so that a person in charge is registered.

At this time, the person in charge checks whether or not predetermined conditions (double booking or qualification of the worker) are satisfied. If the predetermined conditions are satisfied, the person in charge confirms the work process, and if the predetermined conditions are not satisfied, the person in charge can notify of the error information in the work process of the process management table and the personnel management table.

### CITATION LIST

### Patent Literature

PATENT LITERATURE 1: JP 2004-249804 A
PATENT LITERATURE 2: JP 2010-225017 A

### SUMMARY OF INVENTION

### Technical Problem

However, in the vehicle maintenance support system such as PATENT LITERATURES 1 and 2, the time schedule information of the worker (work pit), work information (work content or working time) relevant to vehicle maintenance, and the skill information of the worker are acquired in advance, so that it is possible to notify of error information if double booking or unqualified workers are assigned when the work (work process) is assigned to the time schedule of a predetermined worker (work pit), but this is merely an operation of the administrator or the like for assigning the work on the computer screen.

For this reason, there has been a demand for a support device (support system) that enables the administrator of an automobile maintenance shop or the like to more efficiently manage the process of the work relevant to vehicle maintenance.

Specifically, there has been a demand for a support device for automatically (almost automatically) assigning the work relevant to vehicle maintenance to predetermined workers and work pits.

In addition, in the vehicle maintenance support system such as PATENT LITERATURES 1 and 2, the information required to reliably assign the work to the worker and the work pit is acquired in advance, but there has been a demand for a support device (support system) capable of managing the process more accurately by acquiring other necessary information in advance.

The present invention has been made in view of the aforementioned problems, and it is an object of the present invention to provide a vehicle maintenance support device, a vehicle maintenance support method, and a vehicle maintenance support program capable of efficiently and accurately managing the process of a work relevant to vehicle maintenance.

In addition, it is another object of the present invention to provide a vehicle maintenance support device, a vehicle maintenance support method, and a vehicle maintenance support program capable of automatically (almost automatically) assigning a work relevant to vehicle maintenance to predetermined workers and work pits.

### Solution to Problem

According to a vehicle maintenance support device of the present invention, the aforementioned problems are solved in such a manner that a vehicle maintenance support device for assigning a work relevant to vehicle maintenance to a predetermined worker and a predetermined work pit includes: an attribute data acquisition unit that acquires vehicle attribute data indicating attributes of a vehicle to be worked on; a skill data acquisition unit that acquires worker skill data indicating skill information of a worker required to perform the work; an equipment data acquisition unit that acquires pit equipment data indicating equipment information of a work pit required to perform the work; a worker/work pit selection unit that selects a worker having a skill required to perform a specific work and a work pit having required equipment from information of a specific work specified based on the vehicle attributes indicated by the vehicle attribute data, the worker skill information indicated by the worker skill data, and the work pit equipment information indicated by the pit equipment data; a work assignment unit that assigns a specific work to free time of the selected worker and work pit; and a work display unit that displays the assigned specific work on a display screen for each worker and/or work pit.

With the above configuration, it is possible to realize a vehicle maintenance support device capable of efficiently managing the process of the work relevant to vehicle maintenance.

More specifically, since the vehicle maintenance support device includes the worker/work pit selection unit, the work assignment unit, and the work display unit, it is possible to automatically (almost automatically) assign the work relevant to vehicle maintenance to predetermined workers and work pits, for example, by receiving an operation to start an automatic assignment process from the user.

In addition, since the vehicle maintenance support device includes the attribute data acquisition unit, the skill data acquisition unit, and the equipment data acquisition unit, the equipment information of the work pit required to perform the work is acquired in advance. Therefore, it is possible to manage the process of the work relevant to vehicle maintenance more accurately than in the past.

At this time, the information of the specific work may include information of an order of work processes in the specific work, and the work assignment unit may divide the specific work into a plurality of work processes and then assign the specific work for each of the work processes and assign the specific work so that the work processes are arranged in correct time series.

With the above configuration, since, in general, as a series of work relevant to vehicle maintenance, there are work processes in the order of “preliminary inspection”, “acceptance inspection”, “maintenance work”, “intermediate inspection”, and “completion inspection”, the vehicle maintenance support device can perform assignment so that the work processes are arranged in the correct time series. Therefore, it is possible to manage the process of the series of work more accurately.

At this time, the work display unit may display the assigned specific work in a first display area on the display screen for each worker and each work pit and display a list of unassigned specific work in a second display area different from the first display area on the display screen, and a work movement processing unit that receives a selection by a user operation and moves a predetermined specific work, which is not assigned, from the second display area to the first display area to assign the predetermined specific work to free time of a worker and a work pit may be provided.

With the above configuration, for example, a list of specific work that could not be automatically assigned can be displayed separately on the display screen, and a selection by the user operation can be received and assigned manually.

At this time, the work display unit may display a first timetable showing a correspondence between a worker and a working time and a second timetable showing a correspondence between a work pit and a working time in the first display area and display a specific work on each timetable. When a predetermined specific work is moved from the second display area to one of the first timetable and the second timetable displayed in the first display area by receiving a selection by a user operation, the work movement processing unit may assign the predetermined specific work to the one timetable and reflect and assign the predetermined specific work to the other timetable.

With the above configuration, the work relevant to vehicle maintenance can be more efficiently assigned to predetermined workers and work pits. In particular, the first timetable for each worker and the second timetable for each work pit can be efficiently created on the display screen.

At this time, a duplication determination unit, which determines whether or not the same worker or work pit is assigned repeatedly on the same date and time when a predetermined specific work is assigned by the work movement processing unit, and a user notification unit, which notifies of a determination result on the display screen when it is determined that the same worker or work pit is assigned repeatedly, may be provided. When a plurality of work processes in a predetermined specific work are assigned by the work movement processing unit, the duplication determination unit may further determine whether or not the work processes are assigned in correct time series, and when it is determined that the work processes are not assigned in the correct time series, the user notification unit may notify of a determination result on the display screen.

With the above configuration, when manually assigning a specific work (work process of the specific work) that is not automatically assigned, it is possible to assign the specific work (work process of the specific work) more accurately than in the past.

In addition, it is also possible to realize a vehicle maintenance support method for assigning a work relevant to vehicle maintenance to a predetermined worker and a predetermined work pit. In the vehicle maintenance support method, a computer executes: an attribute data acquisition step for acquiring vehicle attribute data indicating attributes of a vehicle to be worked on; a skill data acquisition step for acquiring worker skill data indicating skill information of a worker required to perform the work; an equipment data acquisition step for acquiring pit equipment data indicating equipment information of a work pit required to perform the work; a worker/work pit selection step for selecting a worker having a skill required to perform a specific work and a work pit having required equipment from information of a specific work specified based on the vehicle attributes indicated by the vehicle attribute data, the worker skill information indicated by the worker skill data, and the work pit equipment information indicated by the pit equipment data; a work assignment step for assigning a specific work to free time of the selected worker and work pit; and a work display step for displaying the assigned specific work on a display screen for each worker and/or work pit.

In addition, it is also possible to realize a vehicle maintenance support program causing a computer as a vehicle maintenance support device for assigning a work relevant to vehicle maintenance to a predetermined worker and a predetermined work pit to execute: an attribute data acquisition process for acquiring vehicle attribute data indicating attributes of a vehicle to be worked on; a skill data acquisition process for acquiring worker skill data indicating skill information of a worker required to perform the work; an equipment data acquisition process for acquiring pit equipment data indicating equipment information of a work pit required to perform the work; a worker/work pit selection process for selecting a worker having a skill required to perform a specific work and a work pit having required equipment from information of a specific work specified based on the vehicle attributes indicated by the vehicle attribute data, the worker skill information indicated by the worker skill data, and the work pit equipment information indicated by the pit equipment data; a work assignment process for assigning a specific work to free time of the selected worker and work pit; and a work display process for displaying the assigned specific work on a display screen for each worker and/or work pit.

### Advantageous Effects of Invention

According to the vehicle maintenance support device, the vehicle maintenance support method, and the vehicle maintenance support program of the present invention, it is possible to efficiently and accurately manage the process of a series of work relevant to vehicle maintenance.

In particular, it is possible to strongly support schedule management and resource management of workers (work pits) in a series of work relevant to vehicle maintenance.

In addition, the work relevant to vehicle maintenance can be automatically (almost automatically) assigned to predetermined workers and work pits.

### BRIEF DESCRIPTION OF DRAWINGS

FIG. 1 is a configuration diagram of an entire vehicle maintenance support system according to the present embodiment.

FIG. 2 is a hardware configuration diagram of a vehicle maintenance support device.

FIG. 3 is a functional configuration diagram of a vehicle maintenance support device and a user terminal.

FIG. 4 is a diagram showing a work assignment screen (worker).

FIG. 5 is a diagram showing a work assignment screen (work pit).

FIG. 6 is a diagram showing a vehicle-specific work setting screen.

FIG. 7 is a diagram showing a state in which a work setting window is displayed on a vehicle-specific work setting screen.

FIG. 8 is a diagram showing a worker setting screen.

FIG. 9 is a diagram showing a work pit setting screen.

FIG. 10 is a diagram illustrating a work display process (case 1).

FIG. 11 is a diagram illustrating a work display process (case 2).

FIG. 12 is a diagram illustrating a duplication determination process and a user notification process.

FIG. 13 is a process flow chart showing a vehicle maintenance support method according to the present embodiment.

### DESCRIPTION OF EMBODIMENTS

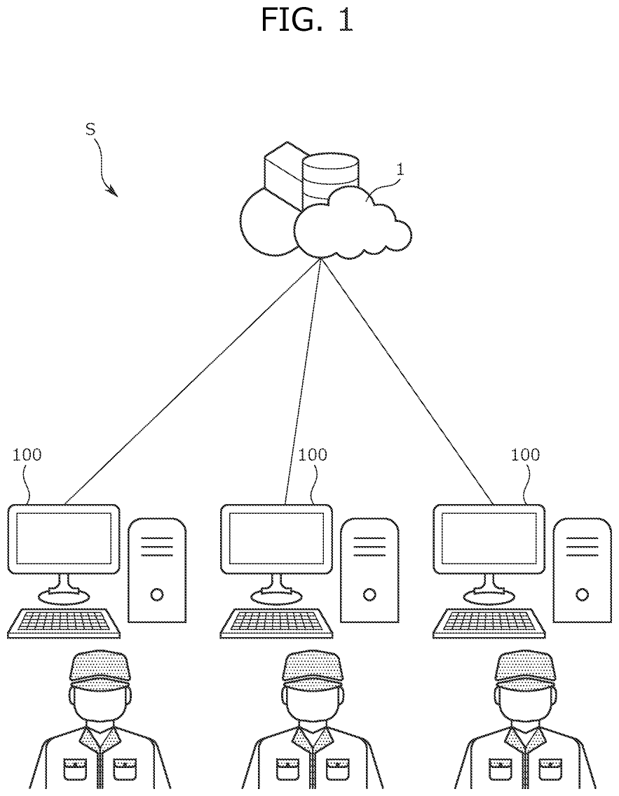

Hereinafter, an embodiment of the present invention will be described with reference to FIGS. 1 to 13.

The present embodiment is a vehicle maintenance support system for assigning a work relevant to vehicle maintenance to a predetermined worker and a predetermined work pit, and relates to an invention including: an attribute data acquisition unit that acquires “vehicle attribute data” indicating attributes of a vehicle to be worked on; a skill data acquisition unit that acquires “worker skill data” indicating skill information of a worker required to perform the work; an equipment data acquisition unit that acquires “pit equipment data” indicating equipment information of a work pit required to perform the work; a worker/work pit selection unit that selects a worker having a skill required to perform a specific work and a work pit having required equipment from information of a specific work specified based on the vehicle attributes indicated by the vehicle attribute data, the worker skill information indicated by the worker skill data, and the work pit equipment information indicated by the pit equipment data; a work assignment unit that assigns a specific work to free time of the selected worker and work pit; and a work display unit that displays the assigned specific work on a display screen for each worker and each work pit.

FIG. 1 shows the overall configuration of a vehicle maintenance support system S according to the present embodiment.

The vehicle maintenance support system S is mainly configured to include a vehicle maintenance support device 1 for assigning each work process of a work relevant to vehicle maintenance to workers and work pits and a user terminal 100 connected to the vehicle maintenance support device 1 through a network and owned by an administrator of an automobile maintenance shop.

Here, the “work relevant to vehicle maintenance” corresponds to, for example, “vehicle inspection” carried out at the automobile maintenance shop or the like, and also corresponds to work such as “new vehicle inspection”, “legal inspection”, “oil change”, “tire change”, and “battery change”.

For example, in the case of “vehicle inspection”, the “work process” corresponds to “preliminary inspection” before warehousing and “acceptance inspection”, “maintenance work”, “intermediate inspection”, and “completion inspection” after warehousing. In the case of “legal inspection”, the “work process” corresponds to “acceptance inspection”, “maintenance work”, and “intermediate inspection”.

The vehicle maintenance support device 1 is a cloud server that provides a software service to the user terminal 100 connected through a network.

Specifically, the vehicle maintenance support device 1 provides the user terminal 100 with a software service especially relevant to the work assignment work in the entire work relevant to vehicle maintenance. More specifically, the vehicle maintenance support device 1 presents a work assignment screen to the user terminal 100, receives the input or selection of a user operation, and updates the work assignment screen in real time to support a plurality of users so as to be able to perform work assignment work at the same time.

In addition, the vehicle maintenance support device 1 has a function as a customer management data server for managing various kinds of customer data obtained from administrators or workers of automobile maintenance shops that are customers and a function as a data server for managing various programs and various kinds of data to support work assignment work.

The user terminal 100 is an information terminal operated by a user such as an administrator of an automobile maintenance shop, and specifically, is a computer such as a PC, a tablet terminal, or a smartphone.

The user terminal 100 is connected to the vehicle maintenance support device 1 through a network, and receives software services from the vehicle maintenance support device 1.

Specifically, it is possible to set work assignment conditions on the display screen by receiving the input or selection of “vehicle attributes”, “worker skill information”, “work pit equipment information”, and the like by the user operation. Then, by receiving the execution operation of the “automatic assignment process” by the user operation, it is possible to perform a process of assigning work to a predetermined worker (work pit) and output a timetable for each worker (work pit) on the display screen.

In addition, it is possible to receive a selection by the user operation and manually assign and display a predetermined work which is not assigned by the above “automatic assignment process” in the timetable.

### <Hardware Configuration of Vehicle Maintenance Support System>

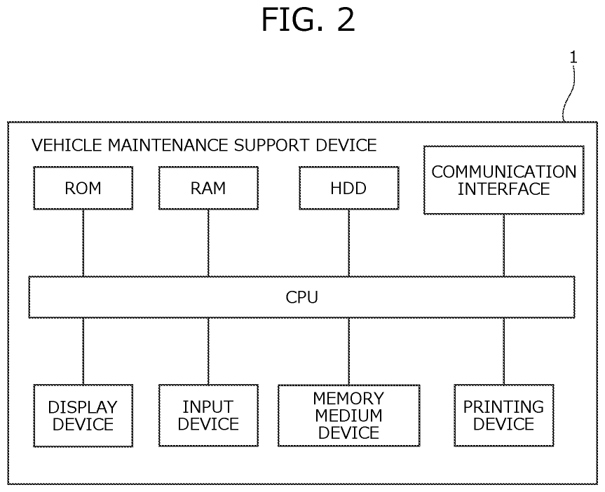

As shown in FIG. 2, the vehicle maintenance support device 1 is a computer including a CPU as a data calculation and control processor, a ROM, a RAM, and an HDD (SSD) as memory devices, and a communication interface for transmitting and receiving information data through a home network or the Internet.

In addition, the vehicle maintenance support device 1 may further include a display device for displaying information of characters or images displayed in a predetermined format, an input device operated by the user when inputting a predetermined command to the CPU, a memory medium device such as an external hard disk, and a printing device for outputting text or image information.

In addition, the user terminal 100 is also a computer having a similar hardware configuration.

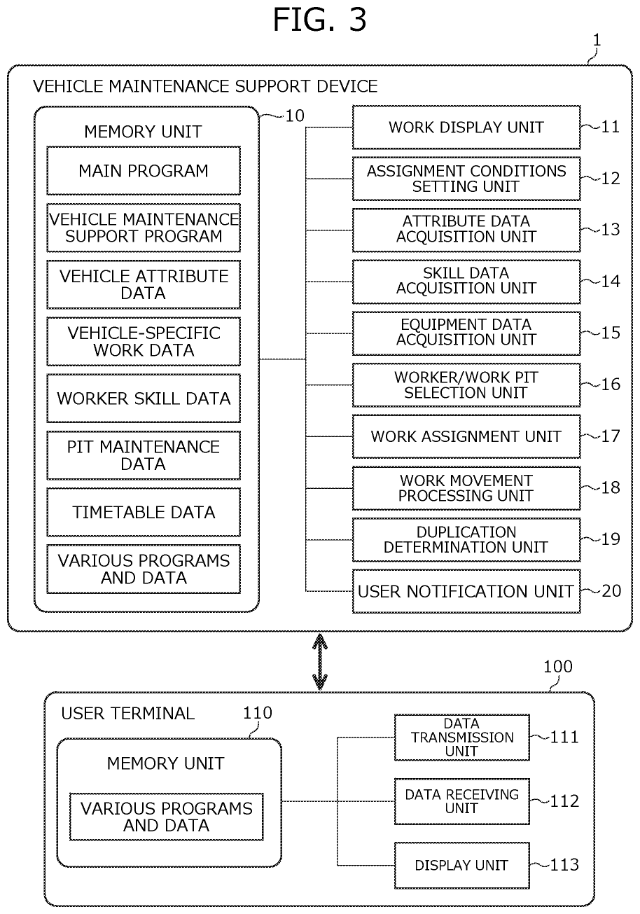

As shown in FIG. 3, a vehicle maintenance support program is stored in the ROM, HDD, and external memory device of the vehicle maintenance support device 1 in addition to a main program that functions as a computer, and these programs are executed by the CPU to realize the functions of the vehicle maintenance support device 1.

### <Function of Vehicle Maintenance Support System>

As shown in FIG. 3, from the functional point of view, the vehicle maintenance support device 1 includes, as main components, a memory unit 10 that stores various programs and data such as “vehicle attribute data”, “vehicle-specific work data”, “worker skill data”, “pit equipment data”, and “timetable data”, a work display unit 11, an assignment conditions setting unit 12, an attribute data acquisition unit 13, a skill data acquisition unit 14, and an equipment data acquisition unit 15, a worker/work pit selection unit 16, a work assignment unit 17, a work movement processing unit 18, a duplication determination unit 19, and a user notification unit 20.

These are configured by a CPU, a ROM, a RAM, an HDD, a communication interface, various programs, and the like.

In addition, from the functional point of view, the user terminal 100 also includes, as main components, a memory unit 110 that holds and stores various programs and various kinds of data, and a data transmission unit 111 that transmits various kinds of data to the vehicle maintenance support device 1, a data receiving unit 112 that receives various kinds of data, and a display unit 113 that displays various display screens relevant to work assignment work.

The “vehicle attribute data” stored in the memory unit 10 is data indicating vehicle attributes registered by the worker in the automobile maintenance shop, and is updated as needed by receiving the input of the user operation, and all the pieces of vehicle attribute data are centrally managed and stored.

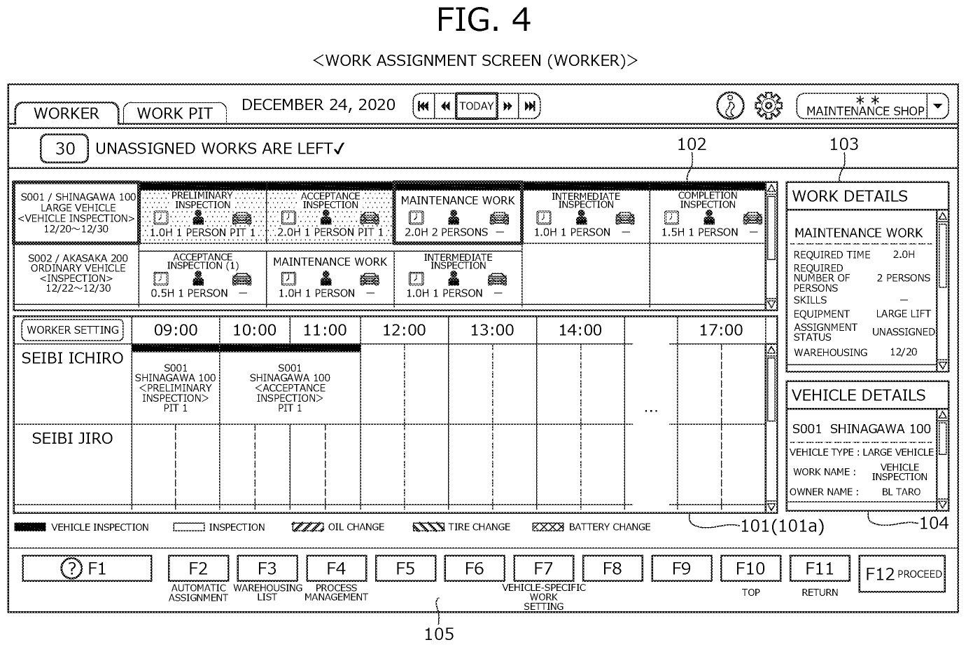

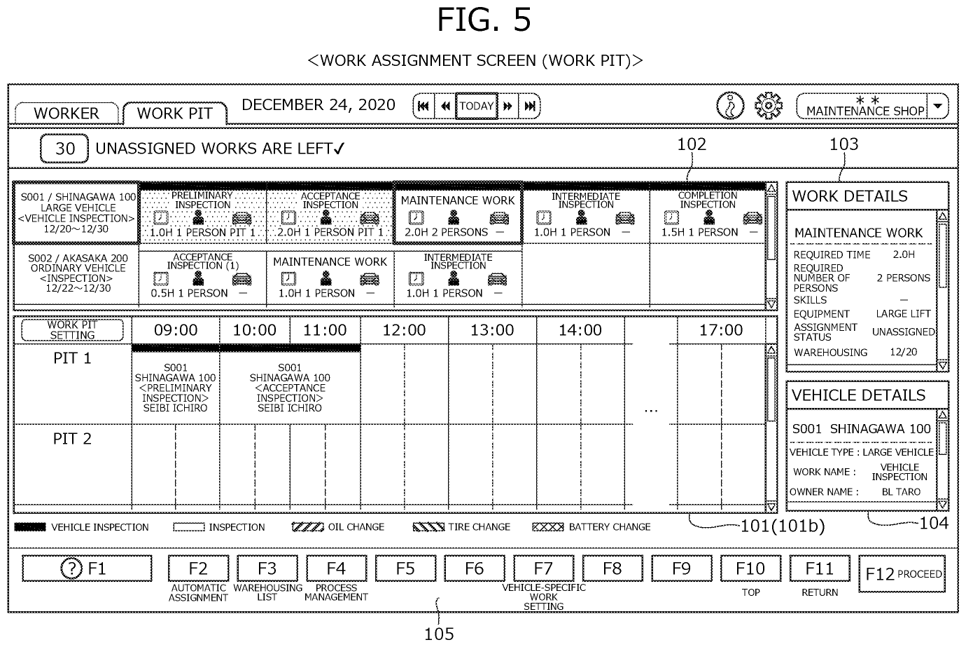

As shown in FIGS. 4 and 5, by referring to the data, it is possible to execute a function of displaying the attribute information of the vehicle on the display screen of the user terminal 100 or a function of specifying the work (work process) required for the vehicle.

More specifically, the vehicle attribute data includes not only the information of “vehicle ID”, “vehicle type”, “vehicle manufacturer”, “vehicle registration number”, “vehicle owner name”, and “desired work” but also the information of “warehousing date (scheduled warehousing date)” and “date of delivery (scheduled delivery date)”.

Looking at an unassigned work display area 102 on the display screen in this example of FIG. 4, it can be seen that a total of 30 vehicles (vehicle attribute data) are registered and listed. Specifically, in the vehicle attribute data at the top, it can be seen that the vehicle information of the vehicle ID “S001”, the vehicle registration number “SHINAGAWA 100”, the vehicle type “LARGE VEHICLE”, the desired work “VEHICLE INSPECTION”, the warehousing date “December 20(12/20)”, and the delivery date “December 30(12/30)” is displayed. In addition, the information of “VEHICLE MANUFACTURER” may be displayed.

The “vehicle-specific work data” is table data indicating the correspondence between the attributes (vehicle type) of the vehicle to be worked on and the required work content, and is master data that is updated as needed by receiving the input of the user operation.

As shown in FIGS. 4 and 5, by referring to the data, it is possible to acquire the information of the work content required for each vehicle type, so that it is possible to execute the automatic assignment function.

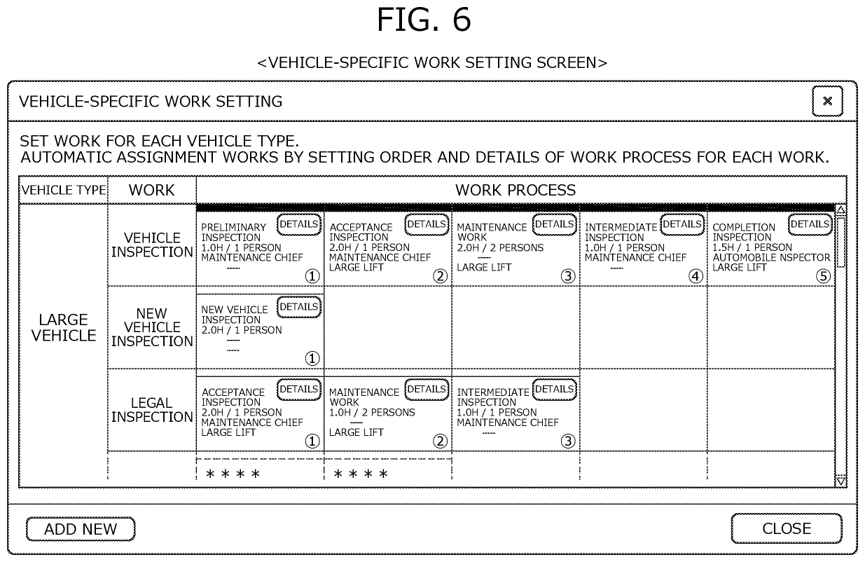

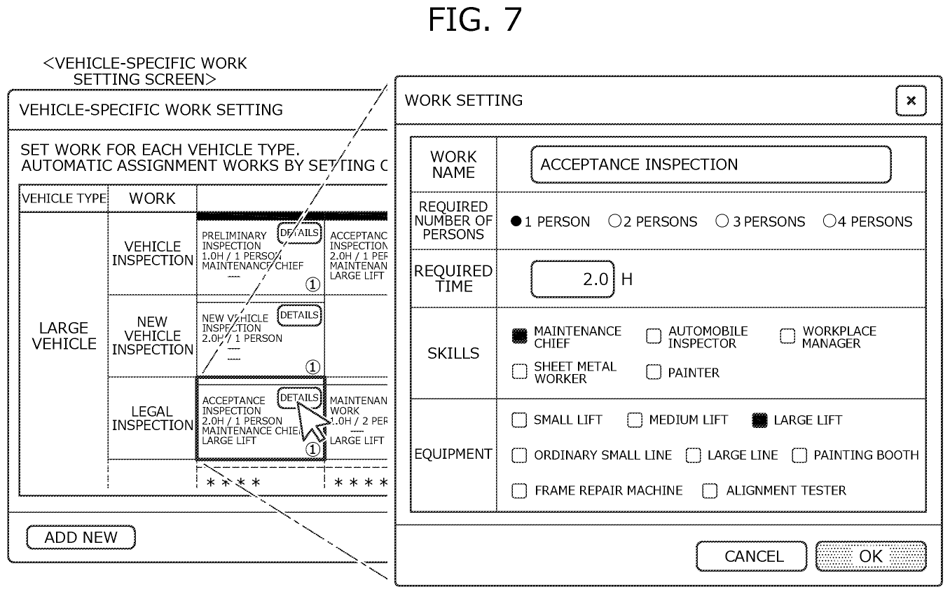

More specifically, the vehicle-specific work data is master data that is completed by setting the required work content for each vehicle type on the vehicle-specific work setting screens shown in FIGS. 6 and 7.

The data includes the information of “vehicle type” as the vehicle attributes, and includes the information of “work name”, “work process name”, and “required number of persons”, “required time”, “skills”, and “equipment” for each work process as the required work content.

Looking at this example of FIG. 6, it can be seen that work process names “PRELIMINARY INSPECTION”, “ACCEPTANCE INSPECTION”, “MAINTENANCE WORK”, “INTERMEDIATE INSPECTION”, and “COMPLETION INSPECTION” are set for the vehicle type “LARGE VEHICLE” and the work name “VEHICLE INSPECTION”. Then, it can be seen that the required time “2.0 H (hours)”, the required number of persons “1 PERSON”, the required skill “MAINTENANCE CHIEF”, and the required equipment “LARGE LIFT” are set for the work process name “ACCEPTANCE INSPECTION”.

In addition, as the “VEHICLE TYPE”, for example, five types of “LARGE VEHICLE”, “ORDINARY VEHICLE”, “LIGHT VEHICLE”, “SMALL VEHICLE”, and “SMALL SPECIAL” are registered. In addition, there may be types such as an electric vehicle, a hybrid vehicle, and a foreign vehicle.

As the “WORK NAME”, for example, six types of “VEHICLE INSPECTION”, “NEW VEHICLE INSPECTION”, “LEGAL INSPECTION”, “OIL CHANGE”, “TIRE CHANGE” and “BATTERY CHANGE” are registered.

In addition, looking at this example of FIG. 7, it can be seen that, when the selection of a display button “DETAILS” in the work process name “ACCEPTANCE INSPECTION” by the user operation is received on the vehicle-specific work setting screen, a work setting window pops up. Then, in the work setting window, it can be seen that the details of the work content can be set for the work process name “ACCEPTANCE INSPECTION”.

More specifically, the details of “REQUIRED NUMBER OF PERSONS”, “REQUIRED TIME”, “SKILLS” and “EQUIPMENT” can be set.

The “worker skill data” is data indicating the skill information of the worker required for the work, and is master data that is updated as needed by receiving the input of the user operation.

By referring to the data, it is possible to acquire the skill information of the worker required for each work process, so that it is possible to execute the automatic assignment function.

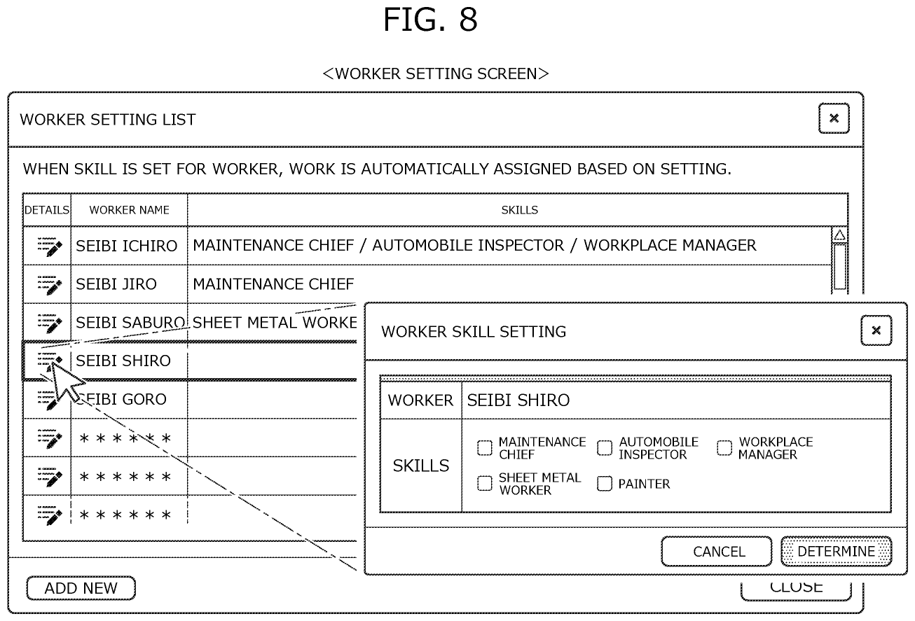

More specifically, the worker skill data is master data that is completed by setting skill information (qualification information) for each worker on the worker setting screen shown in FIG. 8.

The data includes the information of “WORKER NAME” and “SKILLS” as the skill information of the worker.

Looking at this example of FIG. 8, it can be seen that the skill “MAINTENANCE CHIEF/AUTOMOBILE INSPECTOR/WORKPLACE MANAGER” is set for the worker name “SEIBI ICHIRO”. In addition, it can be seen that the skill “MAINTENANCE CHIEF” is set for the worker name “SEIBI JIRO”.

In addition, it can be seen that, when the selection of a display button “DETAILS” in the worker name “SEIBI SHIRO” by the user operation is received on the worker skill screen shown in FIG. 8, a skill setting window pops up. Then, in the skill setting window, it can be seen that the details of the work content can be set for the worker name “SEIBI SHIRO”.

The “pit equipment data” is data indicating the equipment information of the work pit required for the work, and is master data that is updated as needed by receiving the input of the user operation.

By referring to the data, it is possible to acquire the equipment information of the work pit required for each work process, so that it is possible to execute the automatic assignment function.

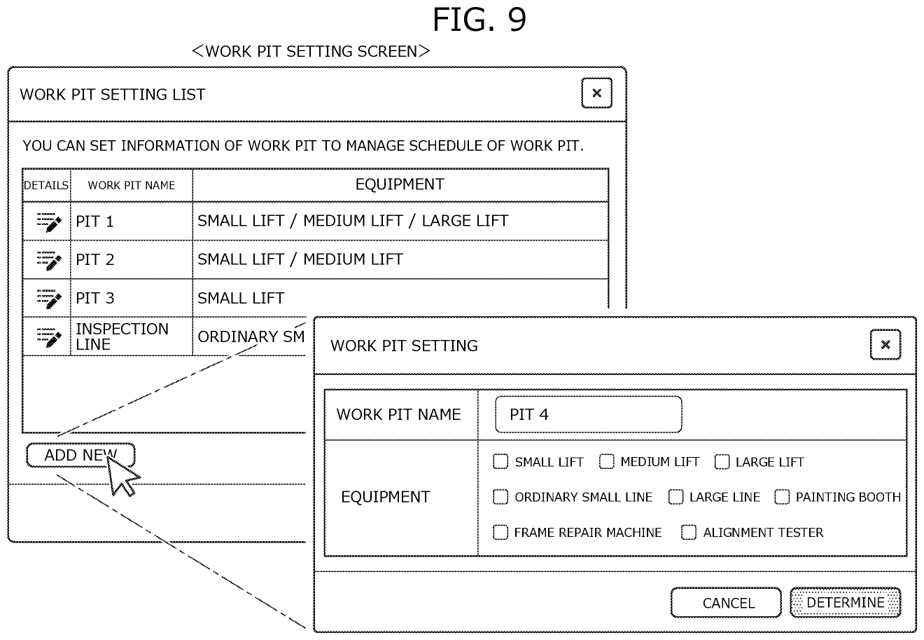

More specifically, the pit equipment data is master data that is completed by setting equipment information for each work pit on the work pit setting screen shown in FIG. 9.

The data includes the information of “WORK PIT NAME” and “EQUIPMENT” as the equipment information of the work pit.

Looking at this example of FIG. 9, it can be seen that the equipment “SMALL LIFT/MEDIUM LIFT/LARGE LIFT” is set for the work pit name “PIT 1” and the equipment “SMALL KIFT/MEDIUM LIFT” is set for the work pit name “PIT 2”.

In addition, it can be seen that, when the selection of a display button “ADD NEW” by the user operation is received on the work pit setting screen shown in FIG. 9, an equipment setting window pops up. Then, in the equipment setting window, it can be seen that the details of the equipment content can be set for the work pit name “PIT 4”.

The “timetable data” is table data indicating the correspondence between the worker (work pit) and the working time, and is master data for managing information in which a predetermined work process is assigned to a predetermined worker (work pit) and working time.

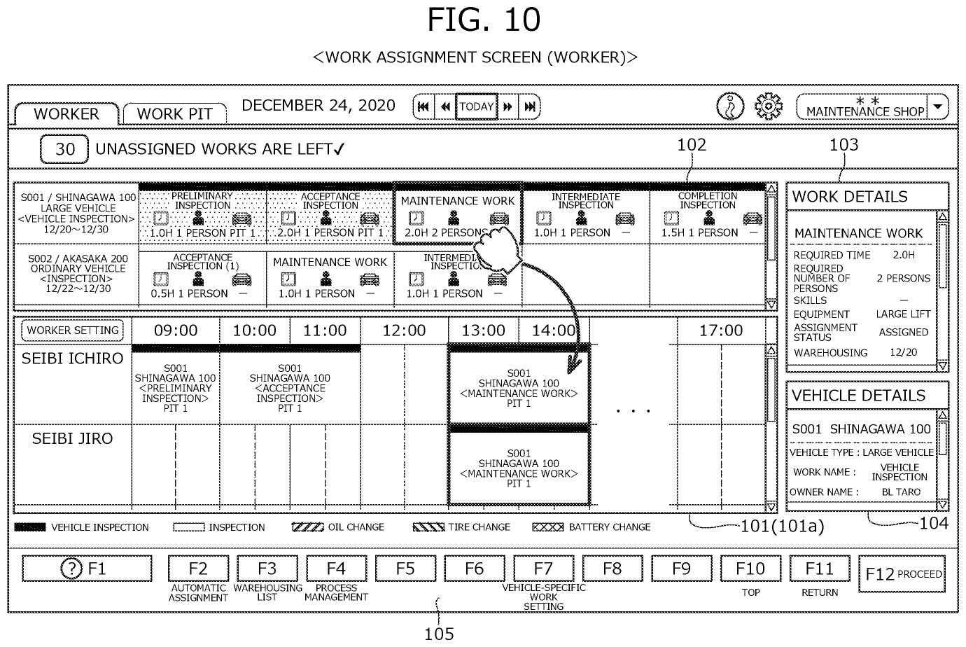

By referring to the data, it is possible to execute a function of displaying the timetable on the display screen (table display area 101) as shown in FIGS. 4 and 5 or a function of receiving the selection of a predetermined work process by the user operation and moving the selected work process onto the timetable or a duplication check function for workers (work pits) in the same working time as shown in FIGS. 10 to 12.

More specifically, the timetable data includes the information of “WORKER (WORK PIT)” at its vertical axis and the information of “working time” at its horizontal axis, and also includes the information of “date”.

Looking at the table display area 101 in this example of FIG. 4, it can be seen that the information of the work process “ACCEPTANCE INSPECTION” is assigned to the worker name “SEIBI ICHIRO” and the working time “10:00 to 12:00” on the date “Dec. 24, 2020 (TODAY)”. Then, it can be seen that the information of the vehicle ID “S001”, the vehicle registration number “SHINAGAWA 100”, and the work pit name “PIT 1” is set in the work process “ACCEPTANCE INSPECTION”.

In addition, looking at the table display area 101 in this example of FIG. 5, it can be seen that the information of the work process “ACCEPTANCE INSPECTION” is assigned to the work pit name “PIT 1” and the working time “10:00 to 12:00”. Then, it can be seen that the information of the vehicle ID “S001”, the vehicle registration number “SHINAGAWA 100”, and the worker name “SEIBI ICHIRO” is set in the work process “ACCEPTANCE INSPECTION”.

In addition, by receiving the selection of a display tab “WORK PIT” by the user operation on the work assignment screen (worker) shown in FIG. 4, it is possible to switch to the work assignment screen (work pit) shown in FIG. 5. Needless to say, it is also possible to switch to the work assignment screen shown in FIG. 4 by receiving the selection of the display tab “WORKER” on the work assignment screen shown in FIG. 5.

As shown in FIGS. 4 and 5, the work display unit 11 displays a work assignment screen on the display screen of the user terminal 100.

The “work assignment screen” is mainly configured to include the table display area 101, the unassigned work display area 102, a work details display area 103, a vehicle details display area 104, and an operation button display area 105.

More specifically, the work display unit 11 displays, on the “table display area 101”, a first timetable 101a showing the correspondence between the worker and the working time and a second timetable 101b showing the correspondence between the work pit and the working time, and displays a work process assigned on each timetable.

In addition, the work display unit 11 displays a list of unassigned work (work process) on the “unassigned work display area 102”, displays detailed information of the work process selected by the user operation on the “work details display area 103”, and displays detailed information of the vehicle selected by the user operation on the “vehicle details display area 104”.

In addition, the work display unit 11 displays, on the “operation button display area 105”, an operation button “F1” for executing the help function, an operation button “F2” for executing the automatic assignment function, and operation buttons “F3” to “F11” for switching the display screen.

As shown in FIGS. 6 to 9, the assignment conditions setting unit 12 receives the input or selection of “vehicle attributes”, “work information required for each vehicle (vehicle type)”, “worker skill information”, and “work pit equipment information” by the user operation on the display screen of the user terminal 100, and sets “work assignment conditions” for performing the automatic assignment process.

As other “worker assignment conditions”, “worker attendance information (free time information)”, “worker performance information”, and “work pit operation information (free time information)” can be set.

In addition, it is possible to prioritize these work assignment conditions. For example, it is advisable to give priority to a vehicle having the earliest “delivery date (scheduled delivery date)” and assign the work.

The attribute data acquisition unit 13 acquires “vehicle attribute data” indicating the attributes of the vehicle to be worked on, and the vehicle attribute data is divided for each vehicle and stored in the memory unit 10.

The skill data acquisition unit 14 acquires “worker skill data” indicating worker skill information required for work, and is stored in the memory unit 10.

The equipment data acquisition unit 15 acquires “pit equipment data” indicating equipment information of the work pit required for work, and is stored in the memory unit 10.

Here, the “vehicle attribute data”, “worker skill data”, and “pit equipment data” are data that is generated by the vehicle maintenance support device 1 when receiving the input or selection by the user operation on the display screen of the user terminal 100. That is, the vehicle maintenance support device 1 generates the above data and acquires the generated data.

In addition, a computer (for example, a management data server) (not shown) connected to the vehicle maintenance support device 1 through a network may generate the above data, and the vehicle maintenance support device 1 may acquire the above data from the computer.

The worker/work pit selection unit 16 selects a worker who has a required skill to perform specific work and a work pit having required equipment from (1) information of specific work that is specified based on the vehicle attributes indicated by the “vehicle attribute data”, (2) worker skill information indicated by the “worker skill data”, and (3) equipment information of the work pit indicated by the “pit equipment data”.

To describe the above (1) in detail, the worker/work pit selection unit 16 specifies the required work from the vehicle attributes indicated by the “vehicle attribute data” by referring to the “vehicle-specific work data”.

Here, the “specific work information” is the work content specified from the information of the “vehicle type” and the “desired work” included in the attributes of the vehicle to be worked on. Specifically, the “work name”, “work process name”, and “required time”, “required number of persons”, “required skills”, and “required equipment” for each work process correspond to the “specific work information”.

In addition, the “worker skill information” specifically corresponds to the information of “worker name” and “skills”, and the “work pit equipment information” specifically corresponds to the information of “work pit name” and “equipment”.

The work assignment unit 17 assigns “specific work” to the free time of the selected worker and work pit. More specifically, the work assignment unit 17 divides the specific work into a plurality of “work processes”, and then assigns the specific work for each of the “work processes” and assigns the specific work so that the “work processes” are arranged in the correct time series.

Then, the work display unit 11 displays the assigned work process in the table display area 101 on the display screen for each worker and each work pit, and displays an unassigned work process in the unassigned work display area 102 on the display screen.

In addition, when a plurality of workers (work pits) are selected, for example, the same worker (work pit) may be preferentially assigned so as to be involved in a series of work processes. In addition, it is preferable to give priority to workers who have a lot of work (work process) experience. In addition, since work is easily assigned to a worker having a plurality of skills, it is preferable to lower the priority of the worker.

In the above, since a series of processes are performed by the worker/work pit selection unit 16, the work assignment unit 17, and the work display unit 11, the “automatic assignment process” is performed.

In order to start the “automatic assignment process”, the selection of the operation button “F2” by the user operation may be received on the work assignment screen shown in FIG. 3.

In addition to the timing of receiving the selection of the operation button “F2”, the “automatic assignment process” may be automatically started at the timing of receiving the reservation of a new vehicle.

As shown in FIG. 10, the work movement processing unit 18 receives a selection by the user operation and moves a predetermined work process, which is not assigned, from the “unassigned work display area 102” to the “table display area 101” to assign the work process to the free time of the worker and the work pit.

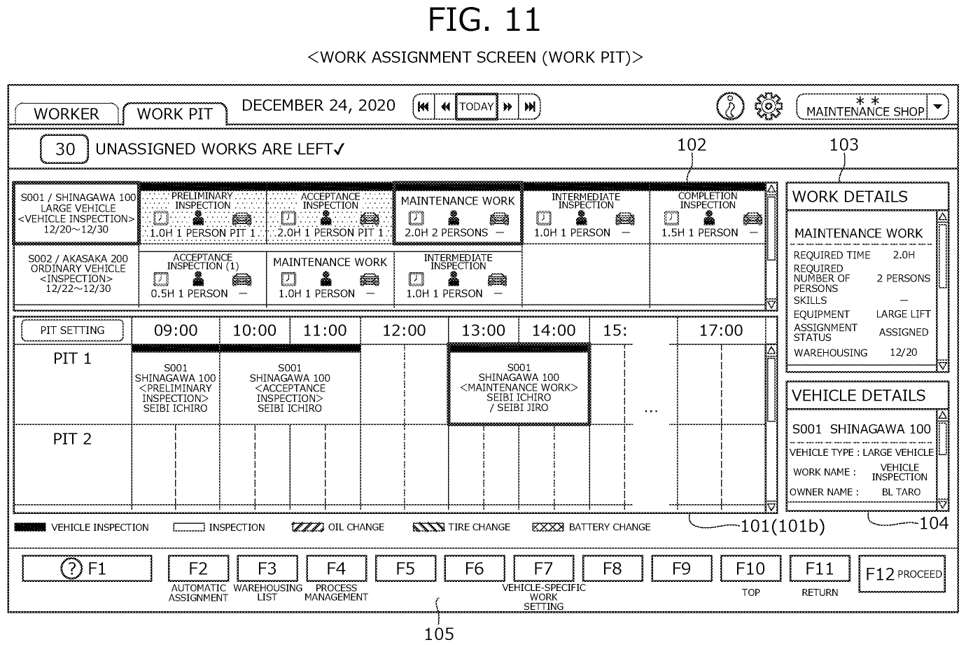

More specifically, as shown in FIG. 10, when a predetermined work process is moved from the “unassigned work display area 102” to the first timetable 101a displayed in the “table display area 101”, the work process is assigned to the first timetable 101a, and as shown in FIG. 11, the work process is also reflected and assigned to a second timetable 101b.

Specifically, on the work assignment screen shown in FIG. 10, the work movement processing unit 18 first receives the selection of the work process “maintenance work”, among the plurality of work processes listed in the unassigned work display area 102, by the user operation. Then, by receiving a move operation (drag and drop operation) by the user, the selected work process is moved from the unassigned work display area 102 to the table display area 101. More specifically, the work process is assigned to a predetermined worker (working time) on the first timetable 101a displayed in the table display area 101. With the above processing, for a predetermined work pit (working time) on the second timetable 101b shown in FIG. 11, the work process is also reflected and assigned.

Looking at this example of FIG. 10, it can be seen that the work process “MAINTENANCE WORK” selected by the user is assigned to the date “DECEMBER 24”, worker names “SEIBI ICHIRO” and “SEIBI Jiro”, and the working time “13:00 to 15:00” on the first timetable 101a.

Then, looking at this example of FIG. 11, it can be seen that the work process “MAINTENANCE WORK” is also automatically reflected and assigned to the date “DECEMBER 24”, the work pit name “PIT 1”, and the working time “13:00 to 15:00” on the second timetable 101b.

In addition, since the “PIT 1” has equipment “LARGE LIFT” and the series of work processes are performed in the “PIT 1”, the “PIT 1” is automatically assigned.

In addition, the work movement processing unit 18 can receive the selection by the user operation and return the predetermined work process from the “table display area 101” to the “unassigned work display area 102”.

That is, the work movement processing unit 18 can freely move a predetermined work process between the “table display area 101” and the “unassigned work display area 102”.

The duplication determination unit 19 determines whether or not the same worker or work pit is assigned repeatedly on the same date and time when a predetermined work process is assigned to the predetermined position on the timetable by the work movement processing unit 18.

In addition, the duplication determination unit 19 determines whether or not the work process is assigned to the worker having a required skill and the work pit having required equipment when a predetermined work process is assigned.

In addition, the duplication determination unit 19 can further determine whether or not the respective work processes are assigned in the correct time series when a plurality of work processes in predetermined specific work are assigned.

The user notification unit 20 notifies of the determination result on the display screen when it is determined by the duplication determination unit 19 that the same worker or work pit is assigned repeatedly.

In addition, even when it is determined that the work process is not assigned to the worker having a required skill and the work pit having required equipment, the user notification unit 20 notifies of the determination result on the display screen.

In addition, the user notification unit 20 can notify of the determination result on the display screen even when it is determined that the respective work processes are not assigned in the correct time series.

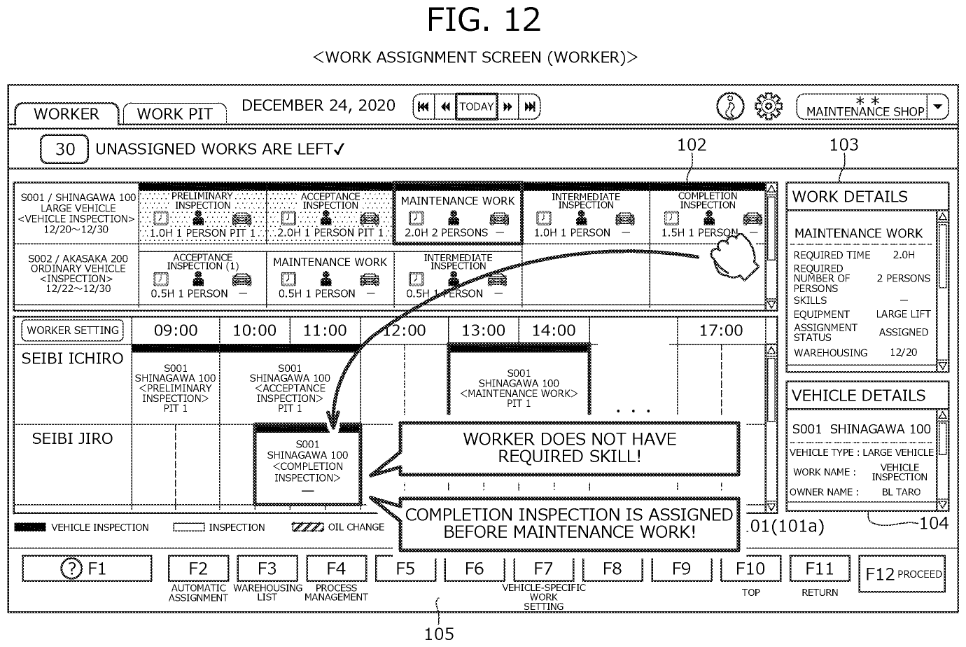

Specifically, when the work process “COMPLETION INSPECTION” is assigned to the worker “SEIBI JIRO” and the holding time “10:30 to 12:00” on the first timetable 101a on the work assignment screen shown in FIG. 12, it is determined whether or not the same worker or presenter is assigned repeatedly on the same date and time.

In addition, it is determined whether or not the worker “SEIBI Jiro” has a skill “AUTOMOBILE INSPECTOR” required for the work process “COMPLETION INSPECTION”, and it is determined whether or not the work pit “PIT 1” has required equipment “LARGE LIFT”.

In addition, it is further determined whether or not a plurality of work processes in the vehicle type “LARGE VEHICLE” and the specific work “VEHICLE INSPECTION” are assigned in the correct time series.

Looking at this example of FIG. 12, since it has been found that the worker “SEIBI Jiro” does not have the required skill “AUTOMOBILE INSPECTOR”, it can be seen that the error content “WORKER DOES NOT HAVE REQUIRED SKILL!” pops up on the display screen and the relevant work process is highlighted with a thick red frame.

In addition, since it has been found that a plurality of work processes are not assigned in the correct time series, it can be seen that the error content “COMPLETION INSPECTION IS ASSIGNED BEFORE MAINTENANCE WORK!” pops up on the display screen and the relevant work process is highlighted with a thick red frame.

In addition, a “red exclamation mark” may be displayed to emphasize the relevant work process.

### <Vehicle Maintenance Support Method>

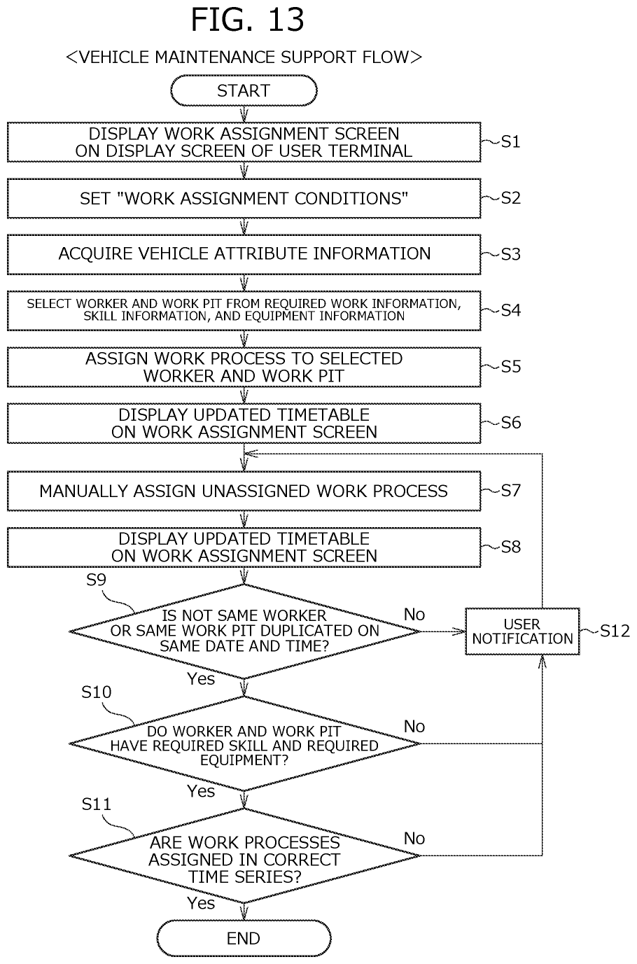

Next, a process of a vehicle maintenance support program (vehicle maintenance support method) executed by the vehicle maintenance support device 1 will be described with reference to FIG. 13.

The above-described program according to the present embodiment is a program obtained by integrating various programs to realize the work display unit 11, the assignment conditions setting unit 12, the attribute data acquisition unit 13, the skill data acquisition unit 14, the equipment data acquisition unit 15, the worker/work pit selection unit 16, the work assignment unit 17, the work movement processing unit 18, the duplication determination unit 19, and the user notification unit 20 as functional components of the vehicle maintenance support device 1 including the memory unit 10, and the CPU of the vehicle maintenance support device 1 executes this vehicle maintenance support program.

The above-described program is executed by receiving an operation instruction from the user.

In addition, the memory unit 10 of the vehicle maintenance support device 1 stores “vehicle attribute data”, “vehicle-specific work data”, “worker skill data”, “pit equipment data”, and “timetable data”.

The vehicle maintenance support flow shown in FIG. 13, first, starts from step S1 in which the work display unit 11 displays the work assignment screen on the display screen of the user terminal 100 as shown in FIG. 4 (FIG. 5).

Looking at the work assignment screen (worker) shown in FIG. 4, it can be seen that the first timetable 101a showing the correspondence between the worker and the working time is displayed. Looking at the work assignment screen (work pit) shown in FIG. 5, it can be seen that the second timetable 101b showing the correspondence between the work pit and the working time is displayed.

Then, in step S2, as shown in FIGS. 6 to 9, the assignment conditions setting unit 12 receives the input or selection of “vehicle attributes”, “work information required for each vehicle (vehicle type)”, “worker skill information”, and “work pit equipment information” by the user operation on the display screen of the user terminal 100, and sets “work assignment conditions” for performing the automatic assignment process.

Then, in step S3, the attribute data acquisition unit 13 acquires the attribute information of the vehicle to be worked on.

Then, in step S4, the worker/work pit selection unit 16 selects a worker who has a required skill for the work process of the specific work and a work pit having required equipment from (1) information of specific work that is specified based on the vehicle attributes, (2) worker skill information, and (3) equipment information of the work pit.

Then, in step S5, the work assignment unit 17 assigns the specific work to the free time of the selected worker and the work pit. At this time, the work assignment unit 17 divides the specific work into a plurality of work processes, and then assigns the specific work for each of the work processes and assigns the specific work so that the work processes are arranged in the correct time series.

Then, in step S6, as shown in FIGS. 4 and 5, the work display unit 11 displays the assigned work process in the table display area 101 on the display screen for each worker and each work pit, and displays an unassigned work process in the unassigned work display area 102 on the display screen.

Then, in step S7, as shown in FIG. 10, the work movement processing unit 18 receives a selection by the user operation and moves a predetermined work process, which is not assigned, from the “unassigned work display area 102” to the “table display area 101”, and assigns the work process to the free time of the worker and the work pit. With the above processing, for a predetermined work pit (working time) on the second timetable 101b shown in FIG. 11, the work process can also be reflected and assigned.

Then, in step S8, the work display unit 11 displays the assigned work process in the table display area 101 on the display screen for each worker and each work pit.

Then, in step S9, the duplication determination unit 19 determines whether or not the same worker or work pit is assigned repeatedly on the same date and time when a predetermined work process is assigned to the predetermined position on the timetable by the work movement processing unit 18.

If it is determined that the same worker or work pit is not assigned repeatedly (step S9: Yes), the process proceeds to step S10.

On the other hand, if it is determined that the same worker or work pit is assigned repeatedly (step S9: No), the user notification unit 20 notifies the user of the determination result to prompt the user to perform the assignment again (step S12), and then the process returns to step S7.

Then, in step S10, the duplication determination unit 19 determines whether or not the work process is assigned to the worker having a required skill and the work pit having required equipment when a predetermined work process is assigned.

If it is determined that the assignment is appropriate (step S10: Yes), the process proceeds to step S11.

On the other hand, if it is determined that the assignment is not appropriate (step S10: No), the user notification unit 20 notifies the user of the determination result to prompt the user to perform the assignment again (step S12), and then the process returns to step S7.

Then, in step S11, the duplication determination unit 19 further determines whether or not the respective work processes are assigned in the correct time series when a plurality of work processes in predetermined specific work are assigned.

If it is determined that the respective work processes are assigned in the correct time series (step S11: Yes), the process of FIG. 13 is ended without providing particular notification to the user.

On the other hand, if it is determined that the respective work processes are not assigned in the correct time series (step S11: No), the user notification unit 20 notifies the user of the determination result to prompt the user to perform the assignment again (step S12), and then the process return to step S7.

Through the above steps S1 to S11, the process of FIG. 13 is completed.

With the configuration of the vehicle maintenance support program described above, it is possible to efficiently and accurately manage the process of the work relevant to vehicle maintenance.

In particular, it is possible to strongly support schedule management and resource management of workers (work pits) in a series of work relevant to vehicle maintenance.

In addition, the work relevant to vehicle maintenance can be automatically (almost automatically) assigned to predetermined workers and work pits.

### <Other Embodiments>

In the embodiment described above, as shown in FIGS. 4 and 5, the work display unit 11 can switch between the display screen shown in FIG. 4 and the display screen shown in FIG. 5 by receiving the selection of the display tab “work pit” by the user operation. However, changes can be made without any particular limitation.

For example, the work display unit 11 may simultaneously display the first timetable 101a shown in FIG. 4 and the second timetable 101b shown in FIG. 5 on the display screen.

In the embodiment described above, as shown in FIGS. 6 to 9, the assignment conditions setting unit 12 receives a predetermined input or selection by the user operation and sets “work assignment conditions” for performing the automatic assignment process. However, changes can be made without any particular limitation.

For example, the vehicle maintenance support device 1 may set “work assignment conditions” in advance, and the assignment conditions setting unit 12 may receive a predetermined input or selection by the user operation and appropriately update the “work assignment conditions” set in advance.

In the embodiment described above, the vehicle maintenance support program is stored in a recording medium that can be read by the vehicle maintenance support device 1, and the process is performed by the vehicle maintenance support device 1 reading and executing the program. Here, the recording medium that can be read by the vehicle maintenance support device 1 refers to a magnetic disk, a magneto-optical disk, a CD-ROM, a DVD-ROM, a semiconductor memory, and the like. In addition, the vehicle maintenance support program may be distributed to the user terminal 100 through a communication line, and the user terminal 100 that receives the distribution may execute the program.

In the embodiment described above, as shown in FIG. 1, the vehicle maintenance support device 1 is a cloud server that provides software services to the user terminal 100 connected through a network, but can be changed without being particularly limited.

Specifically, by installing the vehicle maintenance support program directly on the user terminal so that the user terminal itself functions as a vehicle maintenance support device and the work assignment screen is displayed on the display screen of user terminal, vehicle maintenance may be supported.

In the embodiment described above, the vehicle maintenance support device, the vehicle maintenance support method, and the vehicle maintenance support program according to the present invention have been mainly described.

However, the embodiment described above is merely an example for facilitating the understanding of the present invention, and does not limit the present invention. It is needless to say that the present invention can be modified and improved without departing from the spirit of the present invention and the present invention includes equivalents thereof.

### REFERENCE SIGNS LIST

S: vehicle maintenance support system
1: vehicle maintenance support device
10: memory unit
11: work display unit
12: assignment conditions setting unit
13: attribute data acquisition unit
14: skill data acquisition unit
15: equipment data acquisition unit
16: worker/work pit selection unit
17: work assignment unit
18: work movement processing unit
19: duplication determination unit
20: user notification unit
100: user terminal
101: table display area (first display area)
   101a: first timetable
   101b: second timetable
102: unassigned work display area (second display area)
103: work details display area
104: vehicle details display area
105: operation button display area
110: memory unit
111: data transmission unit
112: data receiving unit
113: display unit

1. A vehicle maintenance support device for assigning a work relevant to vehicle maintenance to a predetermined worker and a predetermined work pit, the device comprising:
an attribute data acquisition unit that acquires vehicle attribute data indicating attributes of a vehicle to be worked on;
a skill data acquisition unit that acquires worker skill data indicating skill information of a worker required to perform the work;
an equipment data acquisition unit that acquires pit equipment data indicating equipment information of a work pit required to perform the work;
a selection unit that selects a worker, who has a skill required to perform a maintenance work on the vehicle specified based on the vehicle attributes indicated by the vehicle attribute data, based on the worker skill data and selects equipment, which is required to perform the maintenance work, based on the work pit equipment information indicated by the pit equipment data;
a work assignment unit that assigns the maintenance work including a plurality of work processes to free time of a worker and a work pit, which are selected by the selection unit, for each of the work processes; and
a work display unit that displays each work process of the assigned maintenance work in a first display area on a display screen for each worker and/or work pit and displays the work process in a second display area on the display screen when there is the work process that is not assigned,
wherein the work assignment unit assigns the maintenance work so that the work processes of the maintenance work are arranged in correct time series, and
the work display unit displays the work process, which is assigned to each of a first timetable showing a correspondence between a worker and a working time and a second timetable showing a correspondence between a work pit and a working time, on the first display area.

2. The vehicle maintenance support device according to claim 1, further comprising:
a work movement processing unit that receives a selection by a user operation and moves the work process in the maintenance work, which is not assigned, from the second display area to the first display area to assign the specific work process of the maintenance work to free time of a worker and a work pit.

3. The vehicle maintenance support device according to claim 2,
wherein, when the work process is moved from the second display area to one of the first timetable and the second timetable displayed in the first display area by receiving a selection by a user operation, the work movement processing unit assigns the work process to the one timetable and reflects and assigns the work process to the other timetable.

4. The vehicle maintenance support device according to claim 2, further comprising:
a duplication determination unit that determines whether or not the same worker or work pit is assigned repeatedly on the same date and time when the work process is assigned by the work movement processing unit; and
a user notification unit that notifies of a determination result on the display screen when it is determined that the same worker or work pit is assigned repeatedly,
wherein, when a plurality of work processes are assigned by the work movement processing unit, the duplication determination unit further determines whether or not the work processes are assigned in correct time series, and
when it is determined that the work processes are not assigned in the correct time series, the user notification unit notifies of a determination result on the display screen.

5. A vehicle maintenance support method for assigning a work relevant to vehicle maintenance to a predetermined worker and a predetermined work pit, the method executed by a computer comprising:
an attribute data acquisition step for acquiring vehicle attribute data indicating attributes of a vehicle to be worked on;
a skill data acquisition step for acquiring worker skill data indicating skill information of a worker required to perform the work;
an equipment data acquisition step for acquiring pit equipment data indicating equipment information of a work pit required to perform the work;
a selection step for selecting a worker, who has a skill required to perform a maintenance work on the vehicle specified based on the vehicle attributes indicated by the vehicle attribute data, based on the worker skill data and selecting equipment, which is required to perform the maintenance work, based on the work pit equipment information indicated by the pit equipment data;
a work assignment step for assigning the maintenance work including a plurality of work processes to free time of a worker and a work pit, which are selected in the selection step, for each of the work processes; and
a work display step for displaying each work process of the assigned maintenance work in a first display area on a display screen for each worker and/or work pit and displaying the work process in a second display area on the display screen when there is the work process that is not assigned,
wherein, in the work assignment step, the maintenance work is assigned so that the work processes of the maintenance work are arranged in correct time series, and
in the work display step, a work process assigned to each of a first timetable showing a correspondence between a worker and a working time and a second timetable showing a correspondence between a work pit and a working time is displayed on the first display area.

6. A computer-readable information storage medium storing a vehicle maintenance support program device for for assigning a work relevant to vehicle maintenance to a predetermined worker and a predetermined work pit, the program causing a computer to execute:
an attribute data acquisition process for acquiring vehicle attribute data indicating attributes of a vehicle to be worked on;
a skill data acquisition process for acquiring worker skill data indicating skill information of a worker required to perform the work;
an equipment data acquisition process for acquiring pit equipment data indicating equipment information of a work pit required to perform the work;
a selection process for selecting a worker, who has a skill required to perform a maintenance work on the vehicle specified based on the vehicle attributes indicated by the vehicle attribute data, based on the worker skill data and selecting equipment, which is required to perform the maintenance work, based on the work pit equipment information indicated by the pit equipment data;
a work assignment process for assigning the maintenance work including a plurality of work processes to free time of a worker and a work pit, which are selected in the selection process, for each of the work processes; and
a work display process for displaying each work process of the assigned maintenance work in a first display area on a display screen for each worker and/or work pit and displaying the work process in a second display area on the display screen when there is the work process that is not assigned,
wherein, in the work assignment process, the maintenance work is assigned so that the work processes of the maintenance work are arranged in correct time series, and
in the work display process, a work process assigned to each of a first timetable showing a correspondence between a worker and a working time and a second timetable showing a correspondence between a work pit and a working time is displayed on the first display area.

7. (canceled)
